(19) United States
(12) Patent Application Publication
(10) Pub. No.: US 2008/0138640 A1
(43) Pub. Date: Jun. 12, 2008

(54) Method of Producing Long Magnesium Material

(76) Inventors: Taichiro Nishikawa, Osaka (JP); Yoshihiro Nakai, Osaka (JP)

Correspondence Address: MCDERMOTT WILL & EMERY LLP, 600 13TH STREET, N.W., WASHINGTON, DC, 20005-3096, US

(21) Appl. No.: 11/886,516

(22) PCT Filed: Feb. 20, 2006
(86) PCT No.: PCT/JP2006/302981

§ 371 Date: Sep. 17, 2007

(30) Foreign Application Priority Data
Mar. 22, 2005 (JP) 2005-082317

(51) Int. Cl. B32B 15/01; B22D 25/00; B22D 11/00

(52) U.S. Cl. 428/544; 164/69.1; 164/476

(57) ABSTRACT

A method of producing a long magnesium material excellent in the plastic workability and a long magnesium material obtained according to the producing method are provided.

Pure magnesium or a magnesium alloy is cast to prepare a cast material and, to the cast material, the plastic working is applied to prepare a long processed material. The plastic working includes a hot process that accompanies a cross sectional area reduction and is applied at a temperature of 250° C. or more. When the hot process is applied, during the process, in the vicinity of a surface of a workpiece, an oxide is generated and present there. The oxide, when the plastic working (secondary working) such as drawing and forging is applied to the formed material, may be a starting point of the crack or disconnection. In this connection, in the invention, a surface layer of the formed material is removed to effectively remove the oxide that becomes a starting point of the crack or disconnection, and thereby the secondary workability is improved.

### TECHNICAL FIELD

The present invention relates to a method of producing a long material made of pure magnesium or a magnesium alloy and a long magnesium material obtained by the method of producing. In particular, the invention relates to a method of producing a long magnesium material suitable for producing a magnesium rod stock and a magnesium wire rod excellent in the plastic workability such as drawing and forging.

### BACKGROUND ART

Mg has the specific gravity (density g/cm³, 20° C.) of 1.74 and is the lightest metal among metals that are used in structural use. Accordingly, a magnesium alloy mainly made of Mg is expected as a material for use in portable devices and automobile parts. For instance, among elongatable magnesium alloy materials for use in such as the drawing and forging, as a rod stock material, there is rod-like one that is obtained by applying hot extrusion to a cast billet obtained by a semi-continuous casting method such as direct chill casting (DC casting). A cast material obtained by the semi-continuous casting method such as the DC casting, in some cases, incorporates crystallized and precipitated products such coarse as several tens μm in a texture or has a crystal structure of a mixed grain structure made of thick and thin grains. Accordingly, when the cast material is as it is subjected to the plastic working such as the forging and drawing, the coarse grains or the crystallized and precipitated products become starting points to cause cracks or disconnections. In this connection, in the rod stock material, the above-mentioned semi-continuously cast material is once more heated and hot extruded to miniaturize grains to improve the plastic workability.

On the other hand, in patent literature 1, a technology where continuous casting is applied with a movable casting mold and at the same time a cooling speed is raised to miniaturize grains is described.

Patent literature 1: International Publication No. 02/083341 pamphlet

### DISCLOSURE OF INVENTION

### Problems to be Solved by the Invention

An elongatable material to which the plastic working (secondary working) such as the forging or drawing is applied is demanded to be free from causing cracks at the forging and from disconnecting at the drawing. The inventors have studied in detail causes of the cracks and disconnections and found that, other than the coarse grains and crystallized and precipitated products, there are causes that generate the cracks and disconnections. Specifically, it is found that an oxide such as MgO present in the vicinity of a surface of a base material becomes a starting point of causing the crack or the disconnection.

The magnesium alloy is generally poor in the plastic workability at room temperature and in many cases subjected to the plastic working in a state heated to 250° C. or more. The extrusion process applied to the semi-continuous cast material is as well applied in a hot state (substantially 250 to 420° C.) and the patent literature 1 describes that a continuous cast material is rolled at 400° C. On the other hand, since Mg is an active metal, when the plastic working (primary working) such as the hot extrusion or hot rolling is applied, an oxide is generated on a workpiece surface and trapped in the vicinity of a workpiece surface during processing. Accordingly, it is considered that, in the vicinity of a surface of an obtained elongatable base material (primary worked material), an oxide is present. When the elongatable material in which an oxide is trapped like this is further subjected to a secondary working such as the drawing or the forging, in some cases, the oxide becomes a starting point of the crack or the disconnection.

In this connection, a primary object of the invention is to provide a method of producing a long magnesium material best suited for obtaining an elongatable material that is difficult to cause the crack and disconnection at the plastic working (secondary working) such as the forging or the drawing. In addition, the other object of the invention is to provide a long magnesium material obtained by the above producing method.

### Means for solving the Problems

In the invention, before proceeding to a secondary working, in order to eliminate an oxide formed on a surface of a primarily processed material, a surface layer of the primarily processed material is removed. Thereby, the object can be achieved. That is, a method of producing a long magnesium material according to the invention includes a step of casting pure magnesium or a magnesium alloy to prepare a cast material, a step of applying the plastic working to the cast material to prepare a long processed material and a step of removing a surface layer of the processed material. Furthermore, the plastic working includes the hot process that accompanies a cross sectional area reduction and is applied at a temperature of 250° C. or more. Still furthermore, the surface layer is a region from 0.01 mm or more to 0.5 mm or less in depth from a surface in a transverse section of the processed material.

Hereinafter, the invention will be detailed.

A term of “magnesium” of a long magnesium material of the invention means so-called pure magnesium made of Mg and impurities or a magnesium alloy made of additive elements, Mg and impurities. As the additive element, at least one kind of element selected from an element group of, for instance, Al, Zn, Mn, Si, Cu, Ag, Y, Zr and so on can be cited. A plurality of elements selected from the element group may be contained. When such additive elements are added, the long processed material of the invention becomes a material excellent in the strength, elongation, high temperature strength, corrosion resistance and so on. A total content of the additive elements is desirably 20 mass percent or less. When the content thereof exceeds 20 mass percent, the cracks or the like are caused at the casting. As a more specific composition that includes the additive elements, for instance, a composition below can be cited.

### I. A composition that contains, by mass percent, 0.1 to 12% Al and a balance of Mg and impurities.

### II. A composition that contains, by mass percent, 0.1 to 12% Al, at least one kind of element selected from a group of three elements of 0.1 to 2.0% Mn, 0.1 to 5.0% Zn and 0.1 to 5.0% Si, and a balance of Mg and impurities.

### III. A composition that contains, by mass percent, 0.1 to 10% Zn, 0.1 to 2.0% Zr and a balance of Mg and impurities.

In the above, the impurities may be elements that are not intentionally added or contain intentionally added elements (additive elements).

As a magnesium alloy having the above composition, magnesium alloys such as AZ based alloy, AS based alloy, AM based alloy, ZK based alloy or the like typical in ASTM, which are typical compositions, may be used. As the AZ based magnesium alloy, for instance, AZ10, AZ21, AZ31, AZ61, AZ91 or the like can be cited. As the AS based magnesium alloy, for instance, AS21, AS41 or the like can be cited. As the AM based magnesium alloy, for instance, AM60, AM100 or the like can be cited. As the ZK based magnesium alloy, for instance, ZK40, ZK60 or the like can be cited. Furthermore, in addition to the compositions I through III, when 0.002 to 5.0 mass percent Ca is contained, the combustion or oxidation at the melting or casting can be preferably suppressed.

In the invention, in the beginning, pure magnesium or a magnesium alloy having the above composition is melted and cast to prepare a cast material. In particular, a cooling speed at the casting is set high. Specifically, 1° C./sec or more is preferable. When the cooling speed is raised, a product precipitated in a structure at the solidifying can be inhibited from growing and thereby coarse precipitates can be inhibited from generating. In addition to this, precipitates precipitated in the cooling step can be inhibited from growing as well. Furthermore, when the cooling speed is raised, grains can be inhibited from growing, and thereby a fine grain structure almost free from coarse grains can be obtained. Specifically, the maximum grain diameter of the crystallized and precipitated products can be made 20 μm or less and the maximum grain diameter of the grains can be made 50 μm or less. The larger the cooling speed is, the finer the crystallized and precipitated products and the grains can be made. More preferable cooling speed is 10° C./sec or more. When, thus, precipitates are inhibited from precipitating and the crystallized and precipitated products and grains are made finer to form a fine cast structure made of columnar grains or particulate grains or a mixed structure of the columnar grains and particulate grains, the plastic workability can be improved. Accordingly, when the cast material is subjected to the plastic working (primary working) such as rolling or the swaging, the cast material can be made difficult to cause the cracks. Furthermore, since the grains can be made finer by the plastic working and thereby the plastic workability can be heightened, an obtained plastically processed material, when subjected to the secondary working such as the drawing and forging, is difficult to cause the disconnections or cracks, that is, excellent in the plastic workability.

When a continuous casting with an endless movable mold is carried out, the cooling speed can be readily sped up. As the movable mold, for instance, (1) a wheel/belt type mold made of a combination of a plurality of wheels (rolls) and belts typical in a wheel/belt method, and (2) a twin belt type mold made of a pair of belts typical in a twin belt method can be cited. In the movable mold that uses wheels and belts, since a surface that comes into contact with a melt appears continuously, a surface state of a cast material can be readily smoothed and the maintenance is easy as well. As the wheel/belt type mold, one that is constituted including a casting wheel that is provided with, on a surface portion (a surface that comes into contact with the melt) thereof, a groove where a melt is flowed in; a pair of driven wheels that are driven by the casting wheel and disposed so as to sandwich the casting wheel; and a belt disposed so as to cover an aperture of the groove so that the melt flowed in the groove may not flow away can be cited. In addition to the above, a tension roller that controls tension of the belt may be provided. When the belt is disposed between the casting wheel and the driven wheel and along a surface of both wheels to form a closed loop, a solidifying surface of the melt can be readily leveled and a cooling speed at which the melt is solidified can be readily maintained constant. Furthermore, when a shape of the groove of the casting wheel is varied, a cast material can be formed into various shapes such as a rectangle. In the case of a shape of a transverse section of a cast material being formed in rectangle, when a minor axis is set at 60 mm or less, since the cooling speed of the transverse section can be made larger, crystallized and precipitated products and grains can be inhibited from growing coarse, thereby a fine structure tends to be obtained. The continuous casting unit described in patent literature 1 may be used. When such a movable mold is used to continuously cast, advantages such that (1) a theoretically limitlessly long cast material can be formed and thereby the mass production can be realized and (2) since a transverse section can be readily homogeneously cooled, a cast material excellent in a surface state, in particular, homogeneous and high in quality in a long direction can be obtained.

During the melting or casting, inconveniences such as that Mg reacts with oxygen in air to burn or blacken owing to oxidation are caused. In order to inhibit the inconveniences from occurring, a configuration where air mixed with an inert gas such as argon gas or a fireproof gas such as SF₆ is filled in a melting furnace or in the vicinity of the movable mold and sealed can be preferably taken. Furthermore, Ca may be added as an additive element to suppress the combustion or oxidation from occurring.

In the next place, in the invention, the plastic working is applied to the cast material obtained as mentioned above to prepare a long rod or wire processed material. In particular, the plastic working (hereinafter referred to as long-length process) applied until a long processed material is prepared from the casting material in the invention includes a process that accompanies a cross sectional area reduction. Accordingly, the long-length processings all may be processes that accompany a cross sectional area reduction or, when a long processed material is finally obtained, the plastic working in the middle may contain a process that does not accompany the cross sectional area reduction (equal area process). As a process that accompanies the cross sectional area reduction, for instance, the rolling, forging (for instance, rotary forging such as swaging), drawing and so on can be cited. Accordingly, a long processed material may be a rolled material, a forged material or a drawn material. More specifically, the long processed material may be a long rolled material obtained by rolling a cast material, a long forged material obtained by swaging a cast material, a long rolled material obtained by further rolling an obtained forged material, or a long wire-drawn material obtained by further wire drawing the obtained rolled material or forged material.

In the process that accompanies the cross sectional area reduction, only one pass of the same kind of process (for instances one pass of the drawing) may be applied, a plurality of kinds of different processes (for instance, swaging and drawing) may be applied, or the same kind of processes may be applied over a plurality of times of at least two passes (for instance, a plurality of passes of the rolling is applied). In particular, when the same kind of plastic working is applied at least two passes, an asymmetric process where a cross sectional shape of a material before the process is applied and a cross sectional shape of a processed material are asymmetric may be applied. As the asymmetric process, for instance, a caliber rolling that uses a plurality of rolls can be cited. The caliber rolling uses two to four rolls having a grove having a predetermined shape on a surface portion thereof. For instance, with two rolls disposed faced each other, a workpiece is allowed passing through between rolls to obtain a rolled material with a predetermined shape, or, with three rolls disposed in triangle, a workpiece is allowed passing through a space surrounded by the rolls to obtain a rolled material with a predetermined shape, or, with four rolls disposed in rectangle with each two thereof faced each other, a workpiece is allowed passing through a space surrounded by the rolls to obtain a rolled material with a predetermined shape. As a shape of a rolled material, a box, oval or round shape can be cited. In the asymmetric rolling, the rollings different in the shape are successively applied. For instance, an oval-round rolling and a box-oval-round rolling can be cited.

Furthermore, at least one pass of the process that accompanies the cross sectional area reduction is carried out at a temperature of 250° C. or more. That is, in the invention, at obtaining a long processed material, the process that accompanies the cross sectional area reduction is applied at least one pass at a temperature of 250° C. or more. The processes that accompany the cross sectional area reduction all may be applied at a temperature of 250° C. or more, or, a process that is carried out at a temperature of 250° C. or less and a process that is carried out at a temperature of 250° C. or more may be combined. For instance, it may well that a cast material is swaged at a temperature of 250° C. or more and the hot processed material is drawn at room temperature. Furthermore, when, in addition to the temperature, an appropriate degree of processing is selected, in an obtained long processed material, grains are made finer; accordingly, the degree of processing of the plastic working (hereinafter, referred to as secondary working) thereafter such as the wire drawing or the forging can be improved. The higher the temperature is, the easier the process that accompanies the cross sectional area reduction can be applied. A more preferable temperature is 350° C. or more. However, when the temperature is too high, since an oxide is excessively forwarded in generation, 500° C. or less, particularly, 450° C. or less is preferable. When a cast material that is heated or a processed material that is subjected to the swaging or rolling is heated to the temperature, a heating unit such as a heater or a high frequency heater may be used to directly heat a material being heated or a heating unit such as a heater may be disposed to a processing member such as a rolling roll, a metal mold or die to indirectly heat the material being heated. When the drawing is applied at room temperature, the degree of processing is lowered (20% or less/one pass) and, before the drawing, a heat treatment ((200 to 450° C.)×(15 to 60 min), preferably (250 to 400° C.)×(15 to 60 min)) is preferably applied to improve the plastic workability.

A long processed material may have a cross sectional shape not only of a circular shape but also of a noncircular irregular shape such as an eclipse, a rectangle or a polygon. The cross sectional shape can be appropriately altered with a hole shape of die or a groove shape of a roll.

The most characteristic feature of the invention exists in removing a surface layer of the long processed material. When the long processed material as mentioned above is obtained, in the invention, the plastic working is applied at a temperature such as 250° C. or more. During the hot process, since an oxide is generated in the vicinity of a surface of the material being formed, an oxide is present in the vicinity of the material being formed. In particular, when the hot processing temperature is raised, an amount of generated oxide increases. Furthermore, even when the hot process is not applied, when a heat treatment is applied in the course of the process, an oxide is generated. In this connection, in the invention, in order to effectively remove the oxide to reduce the inconveniences such as the crack or the disconnection during the secondary working, a surface layer of the long processed material, where the oxide is assumed most contained, is removed. A region where an oxide is present much is a region from a surface to a depth of 0.01 mm in a cross-sectional surface of a long processed material. In this connection, in order to remove at least a region from a surface to a depth of 0.01 mm, the minimum value of a surface layer removed is set to a region from a surface to a depth of 0.01 mm. More preferably, it is a region from a surface to a depth of 0.05 mm. On the other hand, according to an investigation of the inventors, it is found that, when a region from a surface to a depth of 0.5 mm is removed, a raw material excellent in the secondary working could be obtained. Furthermore, when a surface layer being removed is too much, the yield goes down to disturb the productivity. Accordingly, the maximum value of a surface layer removed is set to a region from a surface to a depth of 0.5 mm.

A surface layer may be removed with a lathe or a skin peeling die. As the lathe or the skin peeling die, known ones can be used.

In the long magnesium processed material according to the invention, from which a surface layer is removed as mentioned above, an oxide that becomes a starting point of the crack or the disconnection is reduced or hardly present. Accordingly, the magnesium long processed material is excellent in the plastic workability such as the drawing and the forging. Specifically, when, for instance, with a rolled material or a forged (swaged) material as a long processed material, the drawing is applied as the secondary working, since a surface layer is removed before the drawing, the long processed material according to the invention, being difficult to cause the disconnection during the drawing, is excellent in the drawing workability. Furthermore, when, for instance, with a drawn material as the long processed material, the drawing is further applied as the secondary working (that is, when a surface layer is removed in the middle of the drawing) as well, similarly, the long processed material according to the invention, being difficult to cause the disconnection during the drawing in the secondary working, is excellent in the drawing workability. When the drawing is carried out over a plurality of passes, since the smaller a cross sectional area of the workpiece is, that is, the smaller the workpiece is in a diameter, the larger a surface area ratio of the surface layer in a cross sectional area of the workpiece is, an oxide present in the vicinity of surface affects to tend to cause the disconnection. That is, in the case of the drawing being continued to carry out, when a total degree of processing is small, the disconnection is not caused. However, when the total degree of processing becomes larger to be small in a diameter of the workpiece, because of the oxide, the disconnection tends to occur. As a result, even when the disconnection does not occur in the primary working, the disconnection tends to occur in the secondary working. Accordingly, when the drawing is carried out over a plurality of passes, the removal of the surface layer is very effective in inhibiting the disconnection from occurring. Furthermore, when, with, for instance, any one of the rolled material, forged material and drawn material as the long processed material, the forging is applied as the secondary working, when a surface layer is removed before the forging, the crack is not likely to occur during the forging; that is, the long processed material according to the invention is excellent in the forgeability.

### EFFECTS OF THE INVENTION

As mentioned above, when a surface layer of a processed material obtained by applying a hot process to a forged material is removed, an obtained long magnesium processed material becomes excellent in the secondary working such as the drawing and the forging. Accordingly, a long magnesium processed material according to the invention can be suitably used as an elongatable material.

### BEST MODE FOR CARRYING OUT THE INVENTION

Hereinafter, embodiments of the invention will be described.

### Test Example 1

With a continuous caster provided with a wheel/belt type mold, a molten magnesium alloy is continuously cast and thereby a cast material (cross sectional area, ca 300 mm²; width, 18 mm; and height, 17 mm) made of a magnesium alloy is prepared. The magnesium alloy used in the example is a material equivalent to AZ31 (containing, by mass percent, 3.0% Al; 1.0% Zn; 0.15% Mn; and the balance of Mg and impurities, measured by chemical analysis).

As a continuous caster, one that includes a casting wheel that is provided with, on a surface portion that comes into contact with a melt, a rectangular groove (cross sectional area: ca 300 mm²) where a melt is charged in; a pair of driven wheels that are driven by the casting wheel; a belt disposed so as to cover an aperture of the groove so that the melt charged in the groove may not flow away; and a tension roll that controls tension of the belt is used. The pair of driven wheels is disposed so as to sandwich the casting wheel and the tension roll is disposed behind the three wheels. The belt is disposed along an external periphery of the casting wheel, between the casting wheel and the driven wheel, along an external periphery of the driven wheel, between the driven wheel and the tension roll and along an external periphery of the tension roll to form a closed loop. Between the casting wheel and one of the driven wheels, a feeder having a spout that charges a melt from a melting furnace to the casting wheel is disposed. A melt poured from the melting furnace to the feeder is flowed through the spout in the groove of the casting roll, an aperture of the groove is covered with the belt, and thereby a cast material having a rectangular cross section can be continuously obtained. In the invention, cooling water is flowed inside of the casting wheel to cool the wheel, and a casting speed and cooling speed of the cast material, respectively, are set at 3 m/min and in the range of 10 to 20° C./sec.

In the example, a cross sectional shape of the spout and a cross sectional shape of the groove of the casting wheel are formed into same shape, and a hermetically sealed structure is adopted over from the spout to the casting wheel. Thereby, a structure where the melt does not come into contact with external air in the vicinity of the feeder and the casting wheel is formed. Furthermore, in the invention, an atmosphere where 0.2% by volume of SF₆ is mixed with air is used as an atmosphere in a melting furnace to melt the magnesium alloy.

When an obtained cast material is confirmed with an optical microscope of a cross section thereof, crystallized and precipitated products are recognized. However, a magnitude thereof is 10 μm at the maximum. Furthermore, a crystalline structure is a fine cast structure made of at least one of columnar crystal and particulate crystal.

The obtained cast material is subjected to a plurality of passes of the hot rolling at a temperature of 250° C. or more and 400° C. or less to prepare a rolled material having a circular cross section (wire diameter φ: 13.2 mm). In the example, the oval-round caliber rolling is applied. Specifically, with two rolls each having a groove of a predetermined shape on a surface portion thereof disposed faced to each other, the oval rolling is carried out, followed by continuously applying the round rolling with two rolls each having a groove of a predetermined shape on a surface portion thereof disposed faced to each other. A skin-peeling die is applied to the obtained rolled material to prepare a sample where, in a cross section of the rolled material, a region (surface layer) up to 0.1 mm in a distance from a surface is removed. The sample therefrom a surface layer is removed (wire diameter φ: 13 mm) and a rolled material therefrom a surface layer is not remove (wire diameter φ: 13.2 mm) are subjected to the drawing. The drawing is carried out under the conditions of: processing temperature, 200° C.; area reduction rate per one pass, 10 to 15%; heat treatment of 300° C.×30 min for every 2 or 3 passes; and final wire diameter, φ 8 mm. The drawing is applied to a sample of 10 kg and a rolled material of 10 kg.

As a result, both the sample from which a surface layer is removed and the rolled material from which a surface layer is not removed could be drawn without causing the disconnection. In the drawing from φ13 to φ 8, since an area ratio of a surface layer in a cross section of the workpiece is small, even when an oxide is present in the vicinity of a surface of the workpiece, the disconnection is considered not caused. Furthermore, since a total degree of processing in the processing from φ 13 to φ 8 (substantially 62%) is relatively small, the disconnection is considered not caused. However, when the drawing is further applied under the conditions similar to the above (final wire diameter φ 2.8 mm), in the sample therefrom a surface layer is removed, without causing the disconnection, 10 kg of drawn material having φ 2.8 mm could be obtained. On the other hand, in the sample therefrom a surface layer is not removed, during obtaining 10 kg of drawn material having φ 2.8 mm, the disconnection occurred 5 times. From this, it is confirmed that a material from which a surface layer is removed is excellent in the drawing. In particular, since, when the workpiece becomes thinner, an area ratio of a surface layer in a cross section of the workpiece becomes larger and thereby an oxide present in the vicinity of a surface of the workpiece affects to tend to cause the disconnection, the surface layer can be effectively removed from the viewpoint of inhibiting the disconnection from occurring.

### Test Example 2

From the drawn material (wire diameter φ 8 mm) obtained in test example 1, 20 test pieces having a height of 12 mm are cut, followed by applying swaging to the respective test pieces. The swaging is applied under the conditions of: swaging speed, 12 mm/sec; swaging rate, 70% (height: 3.6 mm); and temperature of 300° C.

As a result, all 20 test pieces cut from a drawn material obtained by drawing a sample therefrom a surface layer is removed could be swaged without causing the crack. On the other hand, in the test pieces cut from a drawn material obtained by drawing a rolled material therefrom a surface layer is not removed, the crack is found in three of twenty. From this, it is confirmed that a material therefrom a surface layer is removed is excellent in the forgeability.

### Test Example 3

Under the conditions similar to that of test example 1, the continuous casting is applied to prepare a cast material (cross sectional area, ca 300 mm²; width, 18 mm; and height, 17 mm), followed by applying hot swaging to the cast material at 400° C., and thereby a hot processed material having a circular cross section (wire diameter φ: 13.2 mm) is prepared. The obtained hot processed material is processed with a skin peeling die to prepare a sample from which a region (surface layer) of which depth from a surface is 0.1 mm is removed. From each of the sample therefrom a surface layer is removed (wire diameter φ: 13 mm) and a hot processed material therefrom a surface layer is not removed (wire diameter φ: 13.2 mm), 20 test pieces having a height of 16 mm are cut. To each of the test pieces, the swaging is applied. The swaging is carried out under the conditions of swaging speed of 16 mm/sec, swaging rate of 70% (height: 4.8 mm) and swaging temperature of 300° C.

As a result, all 20 test pieces cut from a sample therefrom a surface layer is removed could be swaged without causing the crack. On the other hand, in the test pieces cut from a hot processed material therefrom a surface layer is not removed, the crack is found in seven of twenty.

### Test Example 4

Metal materials each having a composition different from the magnesium alloy used in test example 1 are prepared, after cast materials are prepared by similarly continuously casting, the hot rolling is applied to prepare rolled materials. Compositions are shown below.

### (Material Composition)

Pure magnesium equivalent material: a magnesium alloy that contains 99.9 mass percent or more Mg and impurities,

AM60 equivalent material: a magnesium alloy that contains, by mass percent, 6.1% Al, 0.28% Mn and a balance of Mg and impurities,

AZ61 equivalent material: a magnesium alloy that contains, by mass percent, 6.4% Al, 1.0% Zn, 0.28% Mn and a balance of Mg and impurities,

ZK60 equivalent material: a magnesium alloy that contains, by mass percent, 5.5% Zn, 0.45% Zr and a balance of Mg and impurities, and

alloys obtained by adding 0.01 mass percent Ca to each of the AM60 alloy equivalent material, AZ61 alloy equivalent material and ZK60 alloy equivalent material.

A surface layer of each of the rolled materials (φ: 13.2 mm) obtained similarly to test example 1 is removed by use of a skin peeling die to prepare a sample (φ: 13 mm). The samples are drawn under the conditions same as that of test example 1 and it is found that the samples of all compositions could be drawn without causing the disconnection and drawn materials of wire diameter φ 8 mm could be obtained. Furthermore, when the drawn material (wire diameter φ: 8 mm) obtained similarly to test example 2 is cut to prepare 20 test pieces (height: 12 mm) and the swaging test is carried out under the conditions same as that of test example 2, in all test pieces, 20 test pieces all cold be swaged without causing the crack. When, as a comparative example, a rolled material (φ: 13 mm) from which a surface layer is not removed with a skin peeling die is prepared and drawn similarly, in the drawing up to φ 8 mm, the drawing could be carried out without causing the disconnection. However, when an obtained drawn material (φ 8 mm) is cut to prepare 20 test pieces followed by swaging similarly, in 5 of 20, the crack is caused.

Furthermore, in the case of a material to which Ca is not added, a partially oxidized and blackened portion is recognized on a surface of the cast material. However, since when a material to which Ca is added is used, an oxidized portion is not observed on a surface of the cast material, an addition of Ca is confirmed to be effective to inhibit the cast material from being oxidized. However, in the invention, since, even when Ca is not added, a surface layer is removed, an oxide generated in the cast material and an oxide generated owing to the processing such as the rolling and swaging after the casting can be effectively removed. Accordingly, a magnesium base material made of a long magnesium material according to the invention is excellent in the workability in the secondary processing such as the forging and the drawing.

The invention is described in detail and with reference to particular embodiments. However, it is obvious to one familiar in the art that without deviating from a spirit and a scope of the invention various modifications and corrections can be applied.

The application is based on and claims the benefit of priority from Japanese Patent Application No. 2005-082317 filed on Mar. 22, 2005; the entire contents of which are incorporated herein by reference.

### INDUSTRIAL APPLICABILITY

A method of producing a long magnesium material according to the invention can be preferably applied to produce a long magnesium material suitable for an elongatable material to which plastic workings such as the drawing and the forging are applied. Furthermore, the long magnesium material obtained by the producing method of the invention is excellent in the plastic processability and most suitable for an elongatable material.

1. A method of producing a long magnesium material, comprising:
a step of casting pure magnesium or a magnesium alloy to prepare a cast material;
a step of applying the plastic working to the cast material to prepare a long processed material; and
a step of removing a surface layer of the processed material, wherein
the plastic working includes the hot process that accompanies a cross sectional area reduction and is applied at a temperature of 250[ ] C or more; and
the surface layer is a region from 0.01 mm or more to 0.5 mm or less in depth from a surface in a transverse section of the processed material.

2. The method of producing a long magnesium material according to claim 1, wherein
the hot process includes an asymmetric process, the asymmetric process being a process where transversal cross sectional shapes before and after the process are asymmetric.

3. The method of producing a long magnesium material according to claim 1, wherein
the hot process is carried out at 350□C or more.

4. The method of producing a long magnesium material according to claim 1, wherein
a cooling speed during a casting step is 1□C/sec or more.

5. The method of producing a long magnesium material according to claim 4, wherein
a casting process is a continuous casting process that uses an endless movable mold.

6. The method of producing a long magnesium material according to claim 5, wherein
the movable mold is a wheel/belt type mold.

7. The method of producing a long magnesium material according to claim 2, wherein
the asymmetric process is a caliber rolling with a plurality of rolls.

8. The method of producing a long magnesium material according to claim 1, wherein
the surface layer is removed with a skin peeling die.

9. A long magnesium material produced by use of a producing method according to claim 1.
